(19) United States
(12) Patent Application Publication
(10) Pub. No.: US 2002/0060697 A1
(43) Pub. Date: May 23, 2002

(54) Process apparatus for promoting convergence of discussion at electronic conference and method thereof

(76) Inventors: Ikuo Sasazaki, Shizuoka (JP); Takayo Ohba, Shizuoka (JP); Hideaki Takeuchi, Shizuoka (JP); Masaki Gojou, Shizuoka (JP); Yuki Iwanabe, Shizuoka (JP); Naoya Yamamoto, Shizuoka (JP)

Correspondence Address: STAAS & HALSEY LLP, 700 11TH STREET, NW, SUITE 500, WASHINGTON, DC, 20001, US

(21) Appl. No.: 09/892,749

(22) Filed: Jun. 28, 2001

Related U.S. Application Data
(63) Continuation of application No. PCT/JP99/01218, filed on Mar. 12, 1999.

(51) Int. Cl. G09G 5/00; B43L 1/00

(52) U.S. Cl. 345/753; 434/409

(57) ABSTRACT

A discussion roused at an electronic conference in a distributed environment is monitored, and if a predetermined index relating to the amount of a discussion exceeds a prescribed value, the holding of a face-to-face conference is automatically determined. Then, facilities and transportation needed to hold the face-to-face conference are automatically reserved and notified to participants.

### CROSS REFERENCE TO RELATED APPLICATION

This application is a continuation of International PCT Application No. PCT/JP99/01218 filed on Mar. 12, 1999.

### BACKGROUND OF THE INVENTION

1. Field of the Invention

The present invention relates to a process apparatus for automatically setting up a face-to-face conference between participants and making reservations for facilities, transportation, etc., needed for the face-to-face conference in an electronic conference system, and a method thereof.

2. Description of the Related Art

Generally speaking, in an electronic conference system, many and unspecified users exchange information online synchronously or asynchronously. Although in a distributed environment, servers for storing information about a discussion are distributed geographically on a communications network, users who access the same server can exchange information synchronously between them. However, users who access different servers have to exchange information asynchronously because of time lag due to the copying of information between the servers.

In a facilities reservation system, many and unspecified users make reservations synchronously while checking information on whether facilities are available. When both of such a electronic conference system and a facilities reservation system are organized between users who are located apart, each system often exchanges information independently.

In a large-scale electronic conference system and facilities reservation system, generally speaking, users are defined for each area (hereinafter called a “site”), and each user uses his or her own site. Sites are connected via a communication line, and as a whole, a large-scale system can be organized.

In an electronic conference system, the utterance of a user composing a discussion is registered in the database of a server in a data format of an object. By doing so, an utterance is recognized at an electronic conference. An object usually has data and a procedure (method) for the data and can also have link information with other objects.

An object of utterance is managed by an object ID which is uniquely determined within the system. If utterance B, which is a reply to utterance A proposing a certain agenda, is registered, utterance B is linked to utterance A and internally the object of utterance B holds the object ID of utterance A. In this way, the simplest link relation is established.

Such a linkage is called a reply link, and a structure consisting of utterances represented by a tree structure consisting of a plurality of reply links is a discussion. In the tree structure of a discussion, an utterance which is a reply to a specific utterance must have a linkage to an utterance which is the agenda (base) of a discussion. Such a linkage is called a root link.

In an electronic conference system on a large-scale network, a discussion is carried out in a variety of aspects, such as a wide-range electronic conference between areas, an electronic conference at a level of information exchange within a specific area, etc. However, the larger the number of utterances or the larger the number of speakers is, the more complicated the tree structure of a discussion becomes. In such a case, a discussion often diverges without a definite conclusion.

### SUMMARY OF THE INVENTION

An object of the present invention is to provide a process apparatus for promoting the convergence of a discussion even when the number of utterances or speakers increases and a method thereof.

The process apparatus of the present invention comprises a storage unit and a judgment unit.

According to the first aspect of the present invention, the storage unit stores information about a discussion at an electronic conference, and the judgment unit calculates an index relating to an amount of the discussion and judges whether to hold a face-to-face conference based on the index.

According to the second aspect of the present invention, the storage unit stores information about a discussion at an electronic conference, and the judgment unit calculates an index relating to a possibility of the discussion diverging and judges whether to hold a face-to-face conference based on the index.

### BRIEF DESCRIPTION OF DRAWINGS

FIG. 1 shows the principle of the process apparatus of the present invention.

FIG. 2 shows the configuration of the process apparatus.

FIG. 3 shows the tree structure of a discussion.

FIG. 4 shows the structure of an utterance object.

FIG. 5 is a flowchart showing the process (No. 1).

FIG. 6 is a flowchart showing the process (No. 2).

FIG. 7 shows an example of an electronic conference.

FIG. 8 shows the geographical distribution on speakers.

FIG. 9 shows the configuration of the information processing device.

FIG. 10 shows examples of storage media.

### DESCRIPTION OF THE PREFERRED EMBODIMENTS

The detailed preferred embodiments of the present invention are described below with reference to the drawings.

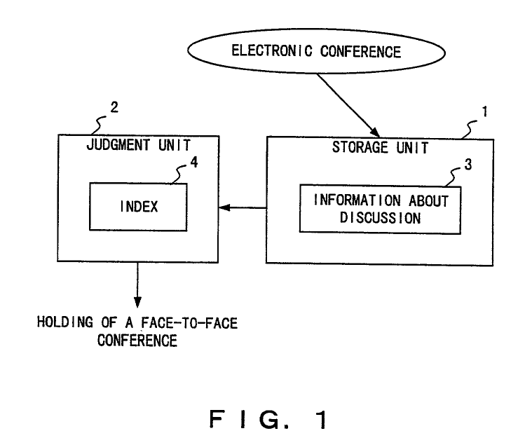

FIG. 1 shows the principle of the process apparatus of the present invention. The process apparatus shown in FIG. 1 comprises a storage unit 1 and a judgment unit 2. The storage unit 1 stores information 3 about a discussion at an electronic conference, and the judgment unit 2 calculates index 4 of the amount of the discussion and judges whether to hold a face-to-face conference, based on the index 4.

The storage unit 1, for example, stores the information about the discussion in a tree structure, the judgment unit 2 calculates the index 4 of the amount of the present discussion based on the information stored in the storage unit 1. The judgment unit 2 estimates the possibility of a discussion diverging, based on the obtained index 4, and determines whether to hold the face-to-face conference among the participants in the electronic conference.

When a discussion at an electronic conference seems to diverge, a definite conclusion can be obtained and the discussion can be easily converged if the participants actually meets each other and discusses. According to the process apparatus shown in FIG. 1, the possibility of a discussion diverging is automatically estimated and to hold a face-to-face conference is automatically determined. Thus, the electronic conference is smoothly switched to a face-to-face conference before the discussion at the electronic conference is complicated, and thereby the convergence of the discussion is promoted.

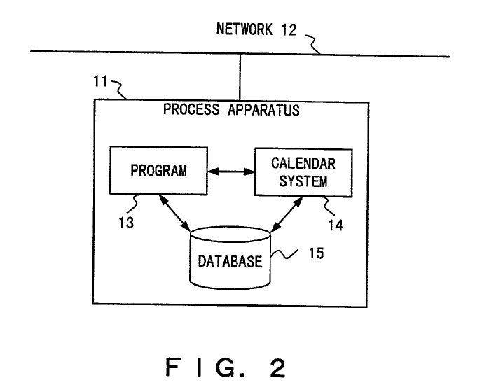

For example, the storage unit 1 shown in FIG. 1 corresponds to the database 15 shown in FIG. 2, and the judgment unit 2 shown in FIG. 1 corresponds to the program 13 shown in FIG. 2. For the index 4 of the amount of the discussion, for example, the number of speakers, the number of utterances at an electronic conference, the depth of the tree structure of a discussion, a data amount in a discussion, etc., are used.

At an electronic conference, the larger the number of utterances or speakers is, the more complicated the tree structure of a discussion becomes. However, the more complicated the tree structure is, often the more important the discussion and thereby the more necessary a definite conclusion becomes. In such a case, if speakers actually meet each other and discuss offline, the discussion sometimes does not diverge and a definite conclusion can be easily obtained.

Although the holding of the face-to-face conference among the participants can be promoted by the judgment of a certain speaker, a person who decides to hold the face-to-face conference and the date of the face-to-face conference are not sure. If a conference room has to be reserved, it requires hands and thereby the face-to-face conference cannot always be held smoothly.

In such a case, the process apparatus in this preferred embodiment monitors the discussion at the electronic conference, and if a predetermined index to the amount of the discussion exceeds a prescribed value, the process apparatus automatically judges that a face-to-face conference should be held. Then, the process apparatus instructs a reservation system to make reservations for both facilities and transportation, and if they are reserved, the process apparatus notifies all the speakers of the holding of a face-to-face conference.

According to such a process apparatus, in particular, in a large-scale electronic conference system covering a lot of areas or countries, an electronic conference can be switched to a face-to-face discussion with an optimal timing, and thereby the convergence of the roused discussion can be automatically promoted.

FIG. 2 shows the configuration of the process apparatus. The process apparatus 11 shown in FIG. 2, for example, is installed in a specific local server of a distributed information system including a network 12. The network 12 covers a lot of areas geographically apart and is connected to other servers supporting an asynchronous electronic conference.

These servers comprise a mechanism for storing origination information to be transmitted to other areas and a mechanism for storing information received from other areas, and realize an asynchronous electronic conference system as a whole by transmitting and receiving information between the servers.

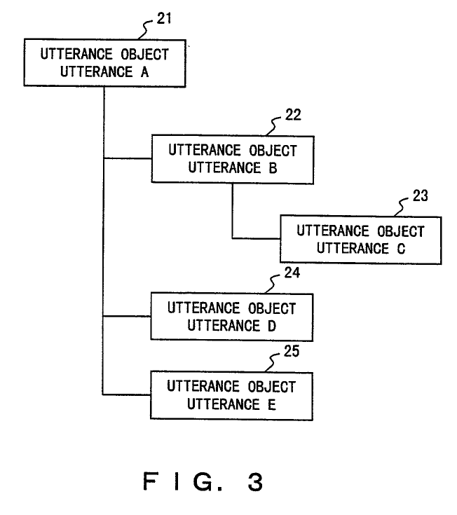

The process apparatus 11 comprises a program 13, a calendar system 14 and a database 15. The process apparatus 11 registers utterance objects in the database 15 and creates the tree of discussion as shown in FIG. 3, for example.

In FIG. 3, utterance objects 21, 22, 23, 24 and 25 correspond to the nodes of the tree, and indicate the objects of utterances A, B, C, D and E, respectively. In this case, utterance A corresponds to an agenda, utterances B, D and E correspond to replies to utterance A, and utterance C corresponds to a reply to utterance B.

The program 13 monitors the progress of a discussion using the number of speakers, the number of utterances, the depth of the tree of discussion, etc., as indexes, based on these utterance objects, and if an index exceeds prescribed values, the program 13 determines to hold a face-to-face conference. Then, the program 13 requests the calendar system 14 to make reservations for both a conference room and transportation, and notifies each speaker of the holding of the face-to-face conference. The calendar system 14 makes reservations for both a conference room and transportation needed for the speakers to participate in the face-to-face conference, according to the request from the program 13.

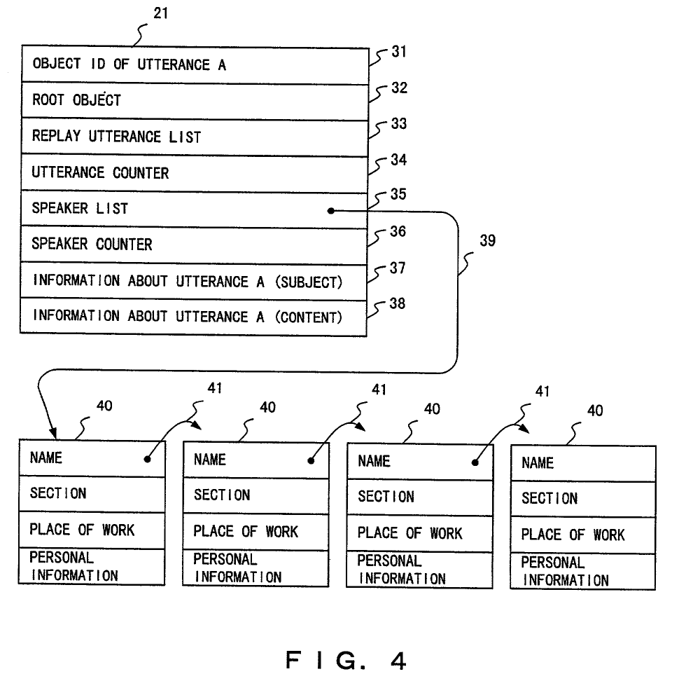

The utterance object 21 shown in FIG. 3, for example, internally stores information as shown in FIG. 4. The object ID 31 is the identification information of the utterance object 21. A root object 32 corresponds to the root link, and is the ID of utterance object corresponding to the root of the tree of discussion to which the utterance object 21 belongs. In this case, since the utterance object 21 corresponds to the root, the root object 32 matches the object ID 31.

A reply utterance list 33 corresponds to the reply link, and indicates the list of the IDs of utterance objects which are reply utterances to the utterance object 21. An utterance counter 34 indicates the number of utterance objects included in the discussion to which the utterance object 21 belongs.

A speaker list 35 indicates the list of speakers in the discussion to which the utterance object 21 belongs, and includes a pointer 39. The pointer 39 indicates the directory information 40 of a speaker linked by a pointer 41, and each directory information 40 includes data, such as the name, section and place of work of each speaker, and personal information. The personal information includes a phone number, address, mail address, etc. A speaker counter 36 indicates the number of directory information 40 (number of speakers), and generally speaking, the value is equal to the value of the utterance counter 34 or less.

Information 37 indicates the subject of utterance, and information 38 indicates the content of utterance. The same applies to other utterance objects.

If a reply utterance to the root of the tree of discussion is received, a new utterance object is created in the database 15, and data increase. At this time, each utterance object internally updates the reply utterance list 33, utterance counter 34, speaker list 35 and speaker counter 36.

The program 13 monitors information stored in utterance objects, and if the utterance counter 34, speaker counter 36 or the depth of the tree exceeds a specific value, the program 13 judges that the discussion may diverge. The depth of the tree can be obtained by checking the number of links of each branch in the direction from the root to the leaves of the tree, based on object IDs described in the reply utterance list 33.

Then, the program 13 obtains the name and e-mail address from the directory information 40 of each speaker, and transmits an e-mail notifying all the speakers of the holding of a face-to-face conference. Alternatively, if there is much time, the opening notice of the face-to-face conference can also be mailed to the addresses described in the directory information 40.

The program 13 can update/refer to the information about utterance objects by transmitting a message for requesting each utterance object to execute a method and receiving the execution result of the method.

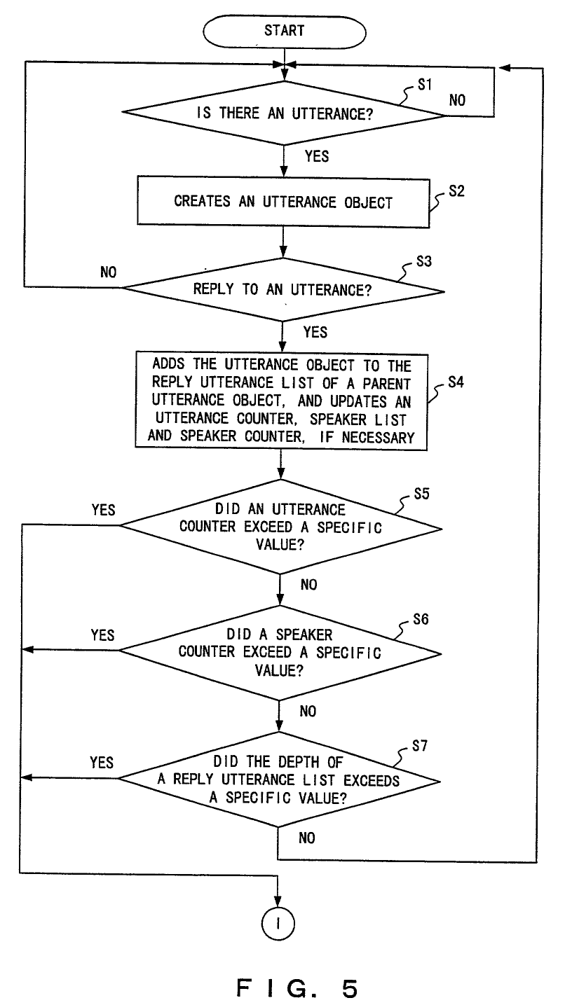

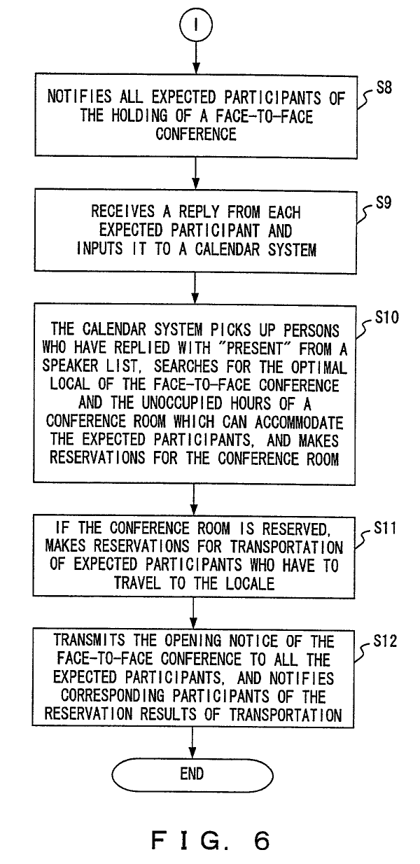

FIGS. 5 and 6 are flowcharts showing the processes of both the program 13 and calendar system 14. The program 13 first regularly repeats checking whether to receive an utterance (step S1 in FIG. 5). Then, if the program 13 receives an utterance, the program 13 creates a corresponding utterance object (step S2), and checks whether the utterance is a reply to another utterance (step S3).

If the received utterance is not a reply, the program 13 repeats processes in steps S1 and after. If the utterance is a reply, the program 13 adds the ID of the created utterance object to the reply utterance list 33 of an utterance object corresponding to its parent node (step S4). The program 13 also updates the information of the utterance counter 34, speaker list 35 and speaker counter 36, if necessary.

In this case, 1 is added to the utterance counter 34. If the speaker of the reply utterance is a new speaker, corresponding directory information 40 is added to the speaker list 35, and 1 is also added to the speaker counter 36. If the speaker of the reply utterance is the existing speaker, neither the speaker list 35 nor speaker counter 36 are updated.

Then, the program 13 checks whether the speaker counter 36 exceeds a specific value (step S5). If the speaker counter 36 does not exceed the specific value, the program 13 checks whether the utterance counter 34 exceeds a specific value (step S6). If the utterance counter 34 does not exceed the specific value, the program 13 checks whether the depth of the tree indicating the reply utterance list 33 exceeds a specific value (step S7). If the depth of the tree does not exceed the specific value, the program 13 judges that there is no possibility of the discussion diverging, and repeats the processes in steps S1 and after.

If in step S5, S6 or S7, any of the respective indexes exceeds the specific value, the program 13 judges that there is the possibility of the discussion diverging. Then, the program 13 designates all the speakers as participant candidates, transmits the opening notice of a face-to-face conference to all the participant candidates according to the speaker list 33 (step S8 in FIG. 6), receives a reply from each participant candidate, and inputs the reply to the calendar system 14 (step S9). At this time, a fixed opening date can be notified, or a possible opening time period or a plurality of opening date candidates can be presented. Each speaker replies to the notice with “present” or “absent” depending on the speaker's convenience.

The calendar system 14 first picks up speakers with a “present” reply from the speaker list 35, and calculates the number of expected participants. Then, the calendar system 14 takes into consideration the place of work, etc., registered in the directory information 40 of each expected participant and searches for an optimal locale (area), a conference room existing in the area which can accommodate all the expected participants, and the unoccupied hours of the conference room. Then, the calendar system 14 makes reservations for a conference room according to the search result (step S10).

For an algorithm for determining the locale, a variety of methods can be thought of. For example, a place of work to which the greatest number of the expected participants belong, out of all the places of work of the expected participants can be selected as the locale. If the places of work of the expected participants are widely distributed, an area located around the center of the distribution can also be selected as the locale. If priority is given to all the expected participants in advance, the place of work of an expected participant with the highest priority can also be selected as the locale.

If a conference room is reserved, the calendar system 14 makes reservations for the transportation, such as a railway, airplane, car, etc., of expected participants who travel up to the locale, and notifies the program 13 of the reservation results of both the conference room and the transportation (step S11).

When receiving the reservation results, the program 13 transmits the opening notice of the face-to-face conference including information about the reserved conference room to all the expected participants, notifies the corresponding participants of the reservation result of transportation (step S12), and terminates the process.

Although in the above-described process, the number of speaker, the number of utterances and the depth of the tree of discussion are used as indexes for estimating the possibility of a discussion diverging, generally the indexes are not limited to these, and other arbitrary indexes can also be used. For example, the total amount of data of information 38 stored in each utterance object can also be used for the index. Alternatively, the number of utterances or the amount of data transmitted within a specific time period can be used as the index.

Alternatively, each expected participants can reply with the designation of desired requirements on the participants of a face-to-face conference in a manner similar to the meeting schedule system shown in “data processing apparatus and method thereof” (Japanese patent laid-open application No. 6-28361).

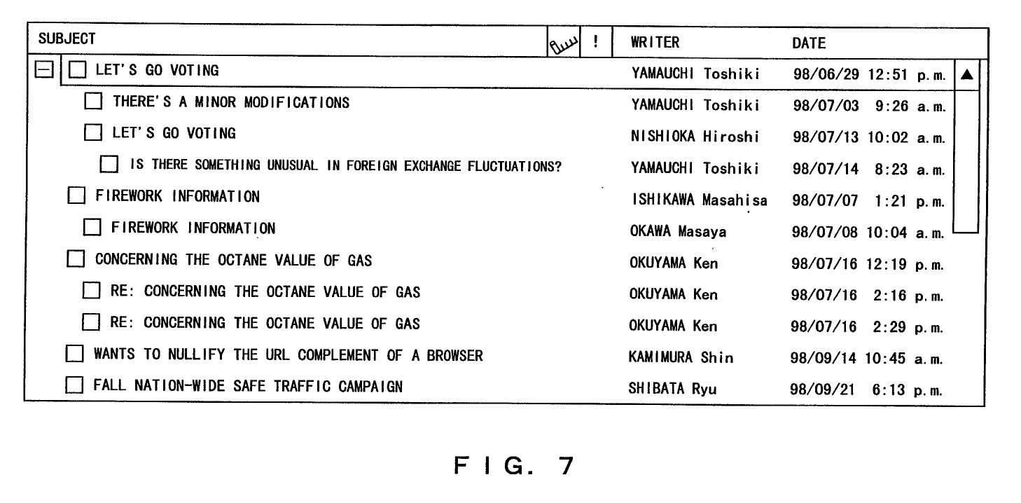

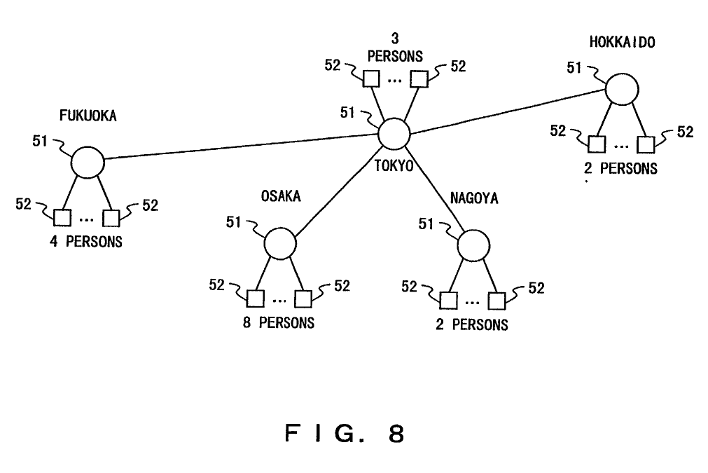

Next, a case where the participants of an in-house electronic conference shown in FIG. 7 are distributed among the areas shown in FIG. 8, is studied. In FIG. 8, a server 51 is located in each of the places of business in Tokyo, Fukuoka, Osaka, Nagoya and Hokkaido, and two to eight terminal sets 52 for speakers are connected to each server 51.

If the holding of a face-to-face conference is determined, the process apparatus 11, which is installed in one of the servers 51, determines the most efficient locale taking the place of work of each speaker (location of the connected server 51) into consideration. In this example, since the number of speakers in Osaka business place is the greatest, a conference room in Osaka business place is reserved and the transportation to Osaka of speakers working in the other places of business are reserved.

At a more general electronic conference where many and unspecified speakers speak regardless of a corporation and an occupation, the same process can be executed taking into consideration the places of residence, etc., instead of the places of work of speakers.

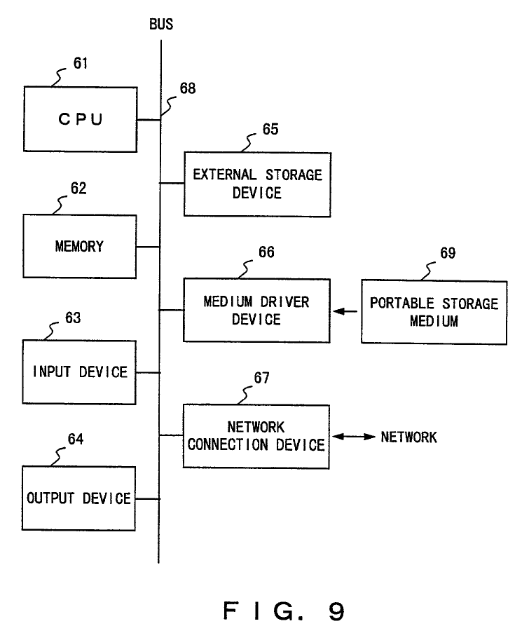

The process apparatus 11 shown in FIG. 2 and the servers 51 and terminal 52 shown in FIG. 8 can be configured using the information processing device (computer) as shown in FIG. 9. The information processing device shown in FIG. 9 comprises a CPU (central processing unit) 61, a memory 62, an input device 63, an output device 64, an external storage device 65, a medium driver device 66 and a network connection device 67, which are connected with each other using a bus 68.

The memory 62 includes, for example, a ROM (read only memory), RAM (random access memory), etc., and stores a program and data used to be processed. The CPU 61 executes necessary processes by running the program using the memory 62.

The input device 63 is, for example, a keyboard, pointing device, touch panel, etc., and is used for an operator or a user to input instructions and information. The output device 64, for example, is a display, printer, speaker, etc., and is used to output inquiries and information to an operator or a user.

The external storage device 65 is, for example, a magnetic disk device, optical disk device, magnet-optical disk device, etc. A user stores the above-described program and data in this external storage device 65, and can also use the program and data by loading the program and data to the memory 62, as the occasion arises. The external storage device 65 can also be used as the database 15 shown in FIG. 2.

The medium driver device 66 drives a portable storage medium 69, and accesses the recorded content. For the portable storage medium 69, an arbitrary computer-readable storage medium, such as a memory card, floppy disk, CD-ROM (compact disk read only memory), optical disk, magneto-optical disk, etc., can be used. The user can also store the above-described program and data in this portable storage medium 69, and can use the program and data by loading the program and data to the memory 62, as the occasion arises.

The network connection device 67 communicates with external devices via an arbitrary network (line), such as a LAN (local area network), etc., and exchanges data accompanying communications. The user can also receive the above-described program and data from an external device, and can use the program and data by downloading the program and data to the memory 62, as the occasion arises.

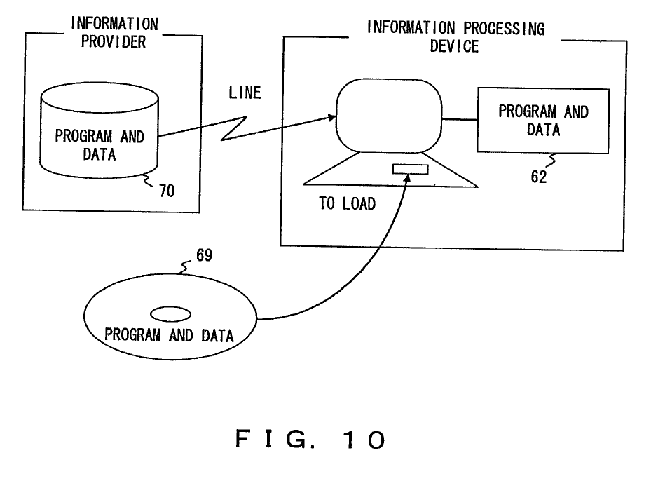

FIG. 10 shows computer-readable storage media for supplying the information processing device shown in FIG. 9 with a program and data. The program and data stored in a portable storage medium 69 or an external database 70 are loaded to the memory 62. Then, the CPU executes necessary processes by running the program and using the data.

According to the present invention, at an electronic conference covering a wide area in a distributed environment or at an electronic conference at a level of information exchange in a specific area, the possibility of a discussion diverging can be automatically judged, and both the issuance of the opening notice of a face-to-face conference among speakers, and the reservations of necessary facilities, etc., can be automatically made. Therefore, even if the number of utterances or speakers increase, the convergence of the discussion can be automatically promoted.

What is claimed is:

1. A process apparatus, comprising:
a storage unit storing information about a discussion at an electronic conference; and
a judgment unit calculating an index relating to an amount of the discussion and judging whether to hold a face-to-face conference based on the index.

2. The process apparatus according to claim 1, further comprising
a notification unit notifying participants of the electronic conference of a holding of the face-to-face conference if said judgment unit determines to hold the face-to-face conference.

3. The process apparatus according to claim 2, further comprising
a reservation unit making reservations for facilities needed to hold the face-to-face conference if said judgment unit determines to hold the face-to-face conference,
said notification unit notifies expected participants of information about reserved facilities.

4. The process apparatus according to claim 3, wherein
said reservation unit makes reservations for transportation needed for the expected participants to participate at the face-to-face conference; and
said notification unit notifies the expected participants of information about reserved transportation.

5. The process apparatus according to claim 1, wherein
said judgment unit uses a number of speakers in the discussion as the index, and if the number of speakers exceeds a specific value, said judgment unit determines to hold the face-to-face conference.

6. The process apparatus according to claim 1, wherein
said judgment unit uses a number of utterances in the discussion as the index, and if the number of utterances exceeds a specific value, said judgment unit determines to hold the face-to-face conference.

7. The process apparatus according to claim 1, wherein
said storage unit stores information about the discussion in a tree structure; and
said judgment unit uses a depth of the tree structure as the index, and if the depth of the tree structure exceeds a specific value, said judgment unit determines to hold the face-to-face conference.

8. The process apparatus according to claim 1, wherein
said judgment unit uses a data amount of the information about the discussion as the index, and if the data amount exceeds a specific value, said judgment unit determines to hold the face-to-face conference.

9. A process apparatus, comprising:
a storage unit storing information about a discussion at an electronic conference; and
a judgment unit calculating an index relating to a possibility of the discussion diverging and judging whether to hold a face-to-face conference based on the index.

10. A process apparatus for executing a process of an asynchronous electronic conference among a plurality of areas in a distributed environment, comprising:
a communications unit transmitting information about a discussion at the electronic conference between areas;
a storage unit storing the information about the discussion; and
a judgment unit judging whether to hold a face-to-face conference based on an amount of the discussion.

11. A computer-readable storage medium on which is recorded a program enabling a computer to execute a process, said process comprising;
calculating an index relating to an amount of a discussion at an electronic conference; and
judging whether to hold a face-to-face conference based on the index.

12. A process method comprising;
recording information about a discussion at an electronic conference;
calculating an index relating to an amount of the discussion; and
judging whether to hold a face-to-face conference based on the index.

13. A process apparatus, comprising:
storage means for storing information about a discussion at an electronic conference; and
judgment means for calculating an index relating to an amount of the discussion and judging whether to hold a face-to-face conference based on the index.
